(19) United States
(12) Patent Application Publication
(10) Pub. No.: US 2013/0146673 A1
(43) Pub. Date: Jun. 13, 2013

(54) INTEGRATED VALVING ROD LUBRICATION CARTRIDGE

(71) Applicants: John S. Lihwa, Willowick, OH (US); Michael S. Cryer, Massillon, OH (US); Heath I. McCartney, Massillon, OH (US); Charles E. Moser, Beloit, OH (US); Michael J. Sebion, Massillon, OH (US)

(72) Inventors: John S. Lihwa, Willowick, OH (US); Michael S. Cryer, Massillon, OH (US); Heath I. McCartney, Massillon, OH (US); Charles E. Moser, Beloit, OH (US); Michael J. Sebion, Massillon, OH (US)

(73) Assignee: GRACO MINNESOTA INC., Minneapolis, MN (US)

(21) Appl. No.: 13/579,379

(22) PCT Filed: Nov. 4, 2010
(86) PCT No.: PCT/US10/55479

§ 371 Date: Nov. 14, 2012

Related U.S. Application Data
(60) Provisional application No. 61/257,896, filed on Nov. 4, 2009.

(51) Int. Cl. B05B 15/00; B05B 7/02

(52) U.S. Cl. CPC B05B 15/00; B05B 7/02
USPC 239/1; 239/142

(57) ABSTRACT

A dispensing gun having a mix head for combining at least two fluid components, with a purge rod slidably positioned within the mix head. The purge rod has a forward position for preventing flow from the component inlets, and a rearward position allowing flow from the component inlets with an actuator for moving the purge rod. The dispensing gun further a lubrication chamber that provides lubricant to the purge rod with the lubricant originating from a lubricant cartridge.

### BACKGROUND

The present invention relates to plural component dispensing devices, and, more particularly, to the lubrication of a mechanical purge rod in a plural component dispensing gun.

Typically, plural components of the type relating to the present invention comprise a resin component which is chemically inert in isolated form and an isocyanate material which is also chemically inert in isolated form. When isocyanate and resin are combined, an immediate chemical reaction begins taking place that results in the cross-linking, curing, and solidification of the mixture. Therefore, the two components are routed separately in a dispensing gun up until near the tip, where they are mixed and dispensed out of the tip. Between dispensing shots of mixture, the mixing area and tip of the dispensing gun must be cleared of mixture or else the mixture will solidify and render the dispensing gun inoperable. However, purging the mixing area and tip of the dispensing gun can be difficult due to the high (and increasing) viscosity of the solidifying plural mixture.

### SUMMARY

According to one embodiment of the present invention, a dispensing gun has a mix head for combining at least two fluid components, with a purge rod slidably positioned within the mix head. The purge rod has a forward position for preventing flow from component inlets, and a rearward position allowing flow from the component inlets, with an actuator for moving the purge rod. The dispensing gun further includes a lubrication chamber that provides lubricant to the purge rod, with the lubricant originating from a lubricant cartridge.

In another embodiment, a dispensing gun has a housing and a lubricant cartridge that is insertable into the housing. The dispensing gun further has a lubricant pathway within the housing that is connected to the lubricant cartridge, and a mixing mechanism that is attached to the housing. The mixing mechanism is for mixing at least two fluid components. A purge rod is slidably positioned in the mixing mechanism. A lubricant pathway within the mixing mechanism is connected with the lubricant pathway within the housing, which allows for lubricant to be delivered to the purge rod.

In another embodiment, a method of operating a dispensing gun includes pressurizing two fluid components and a lubricant cartridge that is attached to the dispensing gun. The method further includes moving a purge rod rearward to allow the two fluid components to flow into and mix in a mixing chamber. Also included is lubricating the purge rod with the pressurized lubricant continually during operation of the dispensing gun, and preventing the lubricant from reaching the mixing chamber.

### BRIEF DESCRIPTION OF THE DRAWINGS

FIG. 1 is a side elevation view of a dispensing gun and a lubrication cartridge.

FIG. 2 is a rear elevation view of the dispensing gun of FIG. 1 with the lubrication cartridge inserted into the dispensing gun.

FIG. 3A is a top cross-section view of a mix head along line 3-3 in FIG. 1, with a mix head dispensing a plural component mix and a purge rod in a rearward position.

FIG. 3B is a top cross-section view of a mix head along line 3-3 in FIG. 1, with a mix head not dispensing a plural component mix and a purge rod in a forward position.

FIG. 4 is a side cross-section view of a dispensing gun along line 4-4 in FIG. 2 showing a piston operated lubricant cylinder.

FIG. 5 is a top cross-section view of a dispensing gun along line 5-5 in FIG. 1 showing a lubricant pathway.

FIG. 6 is a side cross-section view of a mix head along line 6-6 in FIG. 2 showing a lubricant chamber.

FIG. 7 is a side cross-section view of an alternate embodiment of the dispensing gun of FIG. 2 along line 7-7 in FIG. 2 showing a lubricant cartridge disposed in a handle of the dispensing gun.

### DETAILED DESCRIPTION

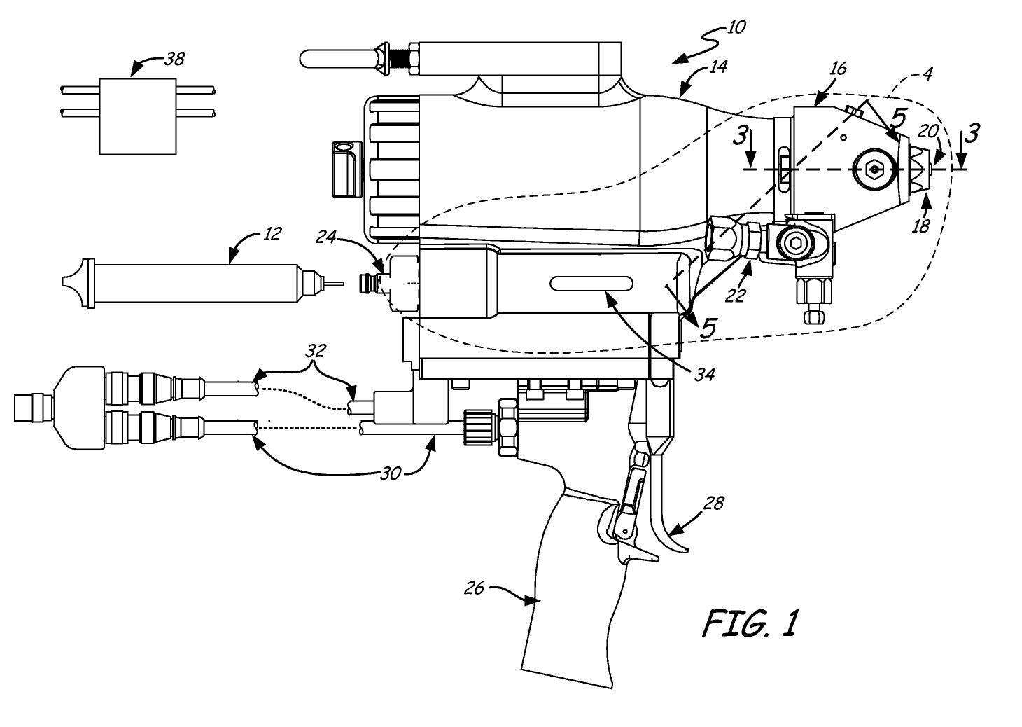

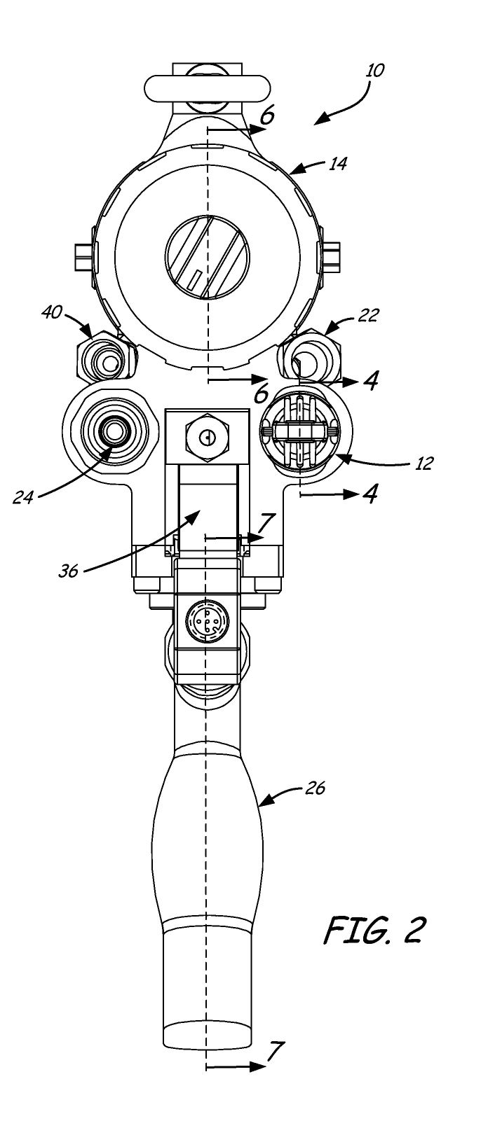

FIG. 1 is a side elevation view of dispensing gun 10 with cartridge 12. FIG. 2 is a rear elevation view of dispensing gun 10. Shown in FIGS. 1-2 are dispensing gun 10, cartridge 12, cylinder 14, mix head 16, tip 18, purge rod 20, first component inlet 22, gas inlet 24, handle 26, trigger 28, control out 30, control in 32, viewing window 34, solenoid 36, metering system 38, and second component inlet 40. The discussion of FIGS. 1-2 will occur simultaneously.

Dispensing gun 10 includes cylinder 14, mix head 16, and handle 26. Mix head 16 is mounted to the front end of cylinder 14 and includes tip 18, purge rod 20, first component inlet 22, and second component inlet 40. First component inlet 22 and second component inlet 40 are connected to mix head 16 near the rear of mix head 16. Tip 18 is connected to the front of mix head 16, and purge rod 20 is slidably positioned within mix head 16 and tip 18. Handle 26 is mounted to the bottom side of cylinder 14, and includes trigger 28 and control out 30. Trigger 28 is pivotally connected to handle 26, and control out 30 is attached to an upper rear portion of handle 26.

Cylinder 14 has gas inlet 24, control in 32, viewing window 34, and solenoid 36. Gas inlet 24 is attached to the rear of cylinder 14, and viewing window 34 is along the side of cylinder 14. Solenoid 36 is attached to the bottom side of cylinder 14, between cylinder 14 and handle 26. Attached to the rear of solenoid 36 is control in 32.

Metering system 38 is fluidly connected to dispensing gun 10 through first component inlet 22, gas inlet 24, and second component inlet 40. Metering system 38 is electrically connected to dispensing gun 10 through control out 30 and control in 32.

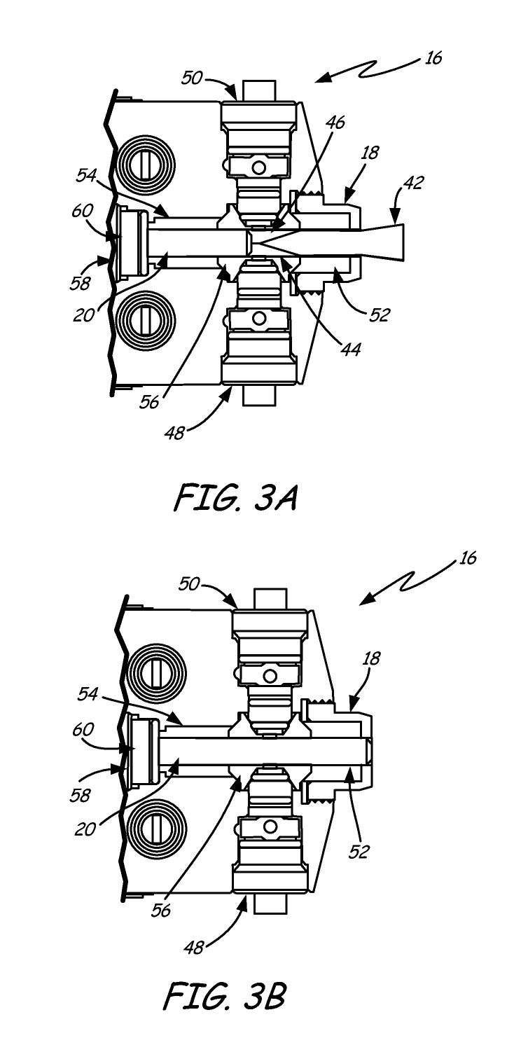

Dispensing gun 10 operates when a user pulls trigger 28. An electrical signal is sent through control out 30 to metering system 38. Metering system 38 then sends the appropriate signal to solenoid 36 through control in 32. Solenoid 36 controls a pneumatically operated actuation system for dispensing gun 10. In one embodiment, solenoid 36 delivers gas from metering system 38 to power a gas piston inside cylinder 14. The gas piston moves purge rod 20 to the rear (to the left as shown in FIG. 1), dispensing plural component mix 42 (as described further with the discussion of FIG. 3A). When the trigger is released, solenoid 36 is controlled to reverse the gas piston. This action moves purge rod 20 forward (to the right as shown in FIG. 1), which stops the flow of plural component mix 42. However, in an alternative embodiment, solenoid 36 is replaced with a mechanical spool valve. Such a spool valve is mechanically controlled by the user pulling or releasing trigger 28. In such an embodiment, the spool valve controls the pneumatically operated actuation system, including the gas piston. Additionally, due to the mechanical structure in this embodiment, control out 30 and control in 32 are not required.

The pressurized gas provided by metering system 38 that enters dispensing gun 10 at gas inlet 24 is also used to pressurize cartridge 12. Pressurization then occurs when cartridge 12 is inserted into cylinder 14. Cartridge 12 contains lubricant that is forced through cylinder 14 into mix head 16, where it lubricates purge rod 20.

The components and configuration of dispensing gun 10 as shown in FIGS. 1-2 allow for plural component mix 42 to be dispensed from dispense gun 10. This occurs in part because cartridge 12 lubricates purge rod 20. As the lubricant in cartridge 12 is used, the user can see the level of lubricant remaining in cartridge 12 through viewing window 34. After the lubricant in cartridge 12 is consumed, cartridge 12 can be removed and a new cartridge 12 can be inserted into dispensing gun 10 in order to ensure the lubrication of purge rod 20.

One skilled in the art can appreciate that the lubricant can comprise one or more of many different suitable lubricants. In the illustrated embodiment, the lubricant is the TSL™ Throat Seal Lubricant available from Graco Inc., Minneapolis, Minn. However, in alternative embodiments other lubricants can be used. In addition, the outside of cartridge 12 is preferably at least translucent if not transparent. This allows a user to see the amount of lubricant in cartridge 12 through viewing window 34.

Shown in FIGS. 3A-3B is a top cross-section view of mix head 16 along line 3-3 in FIG. 1, with mix head 16 dispensing plural component mix 42 in FIG. 3A and not dispensing in FIG. 3B. Shown in FIGS. 3A-3B are mix head 16, tip 18, purge rod 20, plural component mix 42, first component 44, second component 46, first orifice 48, second orifice 50, bearing sleeve 52, lubricant chamber 54, mix module 56, packing nut 58, and packing housing 60.

In FIG. 3A, first orifice 48 and second orifice 50 are attached to respective cavities on opposite sides of mix head 16. First orifice 48 and second orifice 50 are attached and fluidly communicate with first component inlet 22 and second component inlet 40, respectively (as shown in FIG. 2). Positioned in the interior of mix head 16 and between first orifice 48 and second orifice 50 is mix module 56. As stated previously, tip 18 is attached to the front of mix head 16, with bearing sleeve 52 being located inside tip 18.

Behind mix module 56 is lubricant chamber 54. Lubricant chamber 54 is a cavity in mix head 16 containing lubricant that is bounded by mix module 56 in the front and packing housing 60 in the rear. Packing housing 60 is positioned within mix head 16 and is held in place by packing nut 58, with packing nut 58 being attached inside mix head 16. Purge rod 20 is slidably positioned inside mix head 16, specifically within tip 18, bearing sleeve 52, mix module 56, lubricant chamber 54, packing housing 60 and packing nut 58.

Mix head 16 is shown dispensing plural component mix 42. The dispensing occurs because first component 44 and second component 46 are pressurized by metering system 38 (shown in FIG. 1). First component 44 and second component 46 are transported from metering system 38, through first component inlet 22 and second component inlet 40, respectively, and to first orifice 48 and second orifice 50, respectively. When purge rod 20 is retracted towards the rear of dispensing gun 10, the pressure forces first component 44 and second component 46 from first orifice 48 and second orifice 50 into mix module 56, respectively. First component 44 and second component 50 then mix and form plural component mix 42, which begins to solidify. However, plural component mix 42 is dispensed out of dispensing gun 10 through bearing sleeve 52 and tip 18 prior to solidification.

In FIG. 3B, purge rod 20 is shown in a forward position. In this position, purge rod 20 prevents flow of first component 44 and second component 46 from first orifice 48 and second orifice 50, respectively. In addition, when purge rod 20 was moved forward from the rear (as shown in FIG. 3A), purge rod 20 forced out all of first component 44, second component 46, and plural component mix 42 that was in mix module 56, bearing sleeve 52, and tip 18.

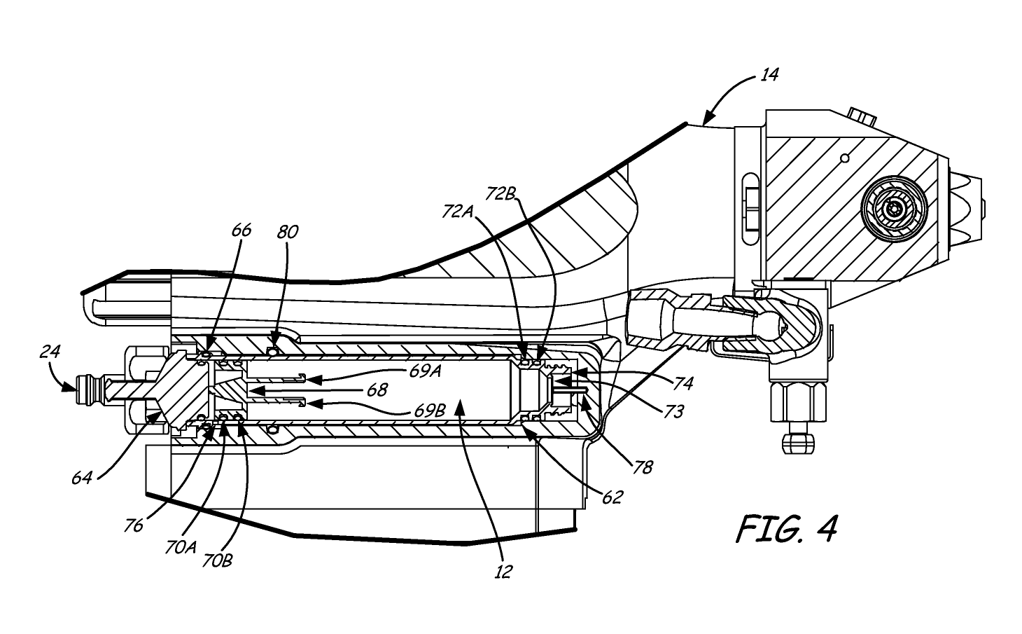

The components and configuration of dispensing gun 10 as shown in FIG. 3 allow for first component 44 and second component 46 to mix and form plural component mix 42, which is dispensed out of tip 18. In addition to stopping the flow of first component 44 and second component 46, the forward motion of purge rod 20 purges dispensing gun 10 of solidifying plural component mix 42. This prevents dispensing gun 10 from being clogged by hardened plural component mix 42. As will be discussed further with FIGS. 4-7, lubrication is provided from cartridge 12 to lubricant chamber 54 to aid the sliding motion of purge rod 20.

Shown in FIG. 4 is a side cross-section view of dispensing gun 10 along line 4-4 in FIG. 2. Shown in FIG. 4 are cartridge 12, cylinder 14, gas inlet 24, cartridge bay 62, cartridge knob 64, rear cartridge seal 66, cartridge piston 68, cartridge piston hooks 69A-69B, cartridge piston seals 70A-70B, front cartridge seals 72A-72B, cartridge ring 73, cartridge end seal 74, cartridge vent 76, piercer 78, and cartridge bay seal 80.

Cartridge 12 has cartridge knob 64 attached at one end. Also near that end, rear cartridge seal 66 is positioned on the exterior of cartridge 12, cartridge piston 68 is slidably positioned in the interior of cartridge 12, and cartridge vent 76 is an aperture through the wall of cartridge 12. Around cartridge piston 68 are cartridge piston seals 70A-70B, at the front of cartridge piston 68 are cartridge piston hooks 69A-69B, and in front of cartridge piston 68 is lubricant. Positioned at the opposite end of cartridge 12 are front cartridge seals 72A-72B and cartridge ring 73. Attached to the very end of cartridge 12 is cartridge end seal 74.

In FIG. 4, cartridge 12 is inserted into cylinder 14, specifically into a cavity in cylinder 14 identified as cartridge bay 62. Attached to cylinder 14 at the front end of cartridge bay 62 is piercer 78. When cartridge 12 is inserted into cartridge bay 62, piercer 78 breaks through cartridge end seal 74. In the illustrated embodiment, cartridge end seal 74 is comprised of a metal foil affixed to the end of cartridge 12.

In the illustrated embodiment, cartridge knob 64 has lobes that extend perpendicular from the center axis of cartridge 12. There are corresponding cuts in cylinder 14 that allow the lobes to pass into cartridge bay 62. After cartridge 12 is inserted all the way into cartridge bay 62, the user can turn cartridge 12 90 degrees. Thereby, the lobes on cartridge knob 64 prevent cartridge 12 from being withdrawn from cartridge bay 62. This is because cylinder 14 does not have corresponding cuts to allow the lobes to exit cartridge bay 62 when cartridge 12 is in the ¼ turned orientation.

Pressurized gas from metering system 38 (as shown in FIG. 1) is directed through gas inlet 24 and into cartridge bay 62. Specifically, the gas is introduced between rear cartridge seal 66 and cartridge bay seal 80, cartridge bay seal 80 being positioned in cartridge bay 62 forward from cartridge vent 76. This allows the gas to enter cartridge 12 behind cartridge piston 68, forcing cartridge piston 68 forward. Because piercer 78 penetrated cartridge end seal 74, lubricant is forced into the front end of cartridge bay 62. However, front cartridge seals 72A-72B prevent the flow of lubricant to the rear of cartridge bay 62.

As the lubricant is consumed, the pressurized gas will drive cartridge piston 68 forward. When cartridge piston 68 is sufficiently forward, cartridge piston hooks 69A-69B will be bent towards each other in order to pass through cartridge ring 73. However, once the forward ends of cartridge piston hooks 69A-69B are past cartridge ring 73, cartridge piston hooks 69A-69B will expand back to their original configuration. In this configuration, cartridge piston 68 is locked forward and can no longer retract.

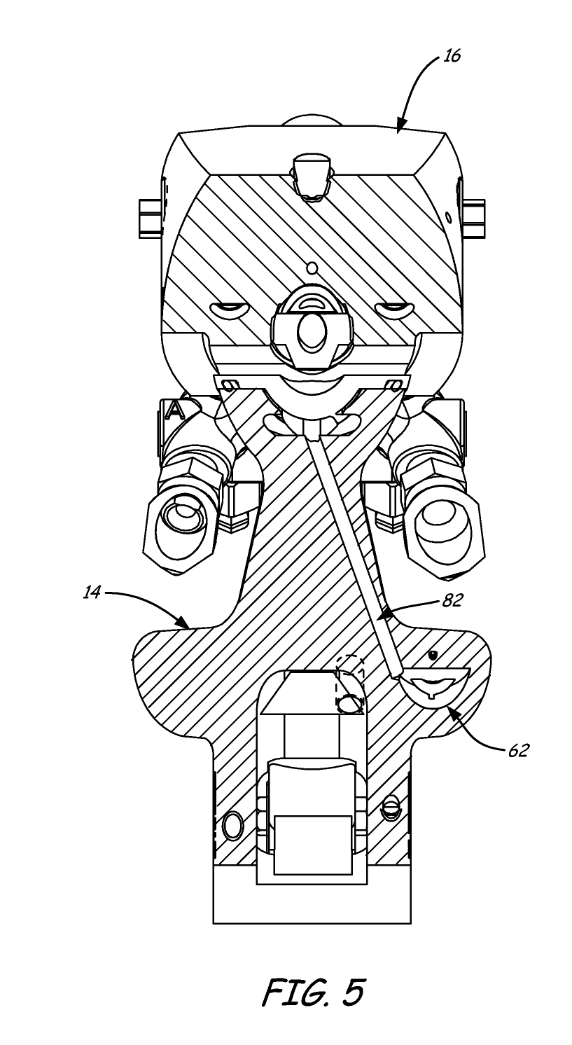

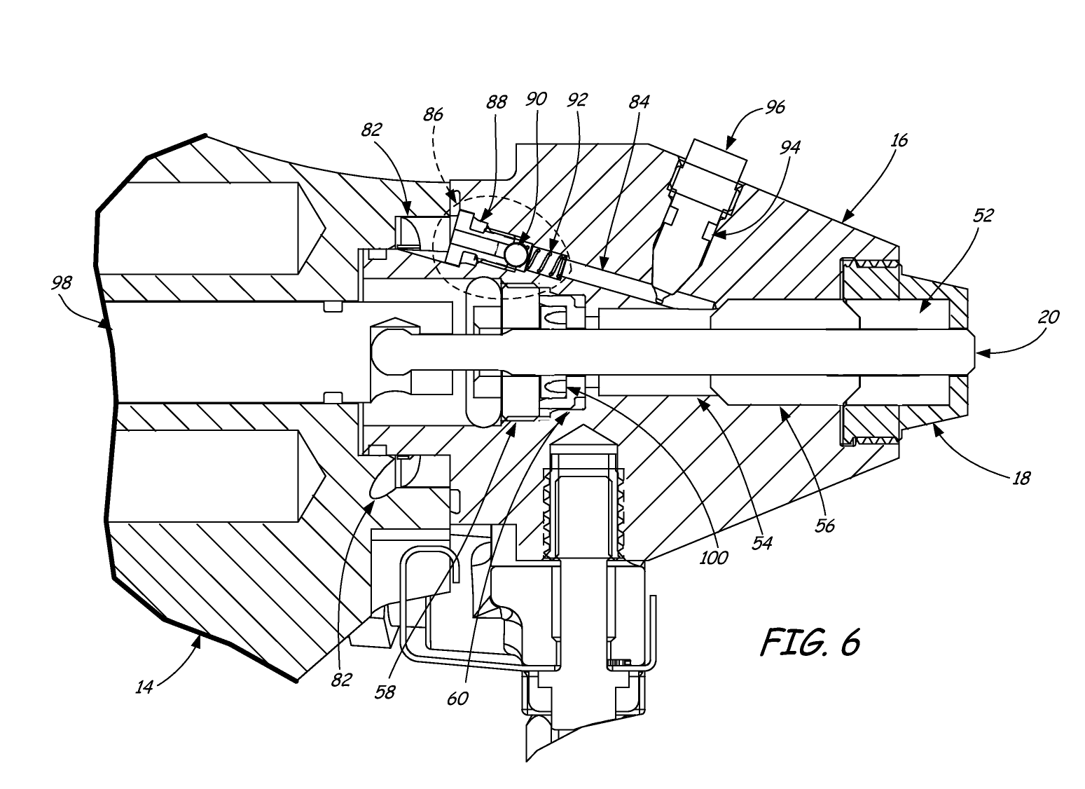

The components and configuration of dispensing gun 10 as shown in FIG. 4 allow for a sealed cartridge 12 to be attached to cylinder 14. Specifically, cartridge 12 is substantially fully enclosed and contained within cylinder 14. From this position, cartridge 12 is opened and pressurized to allow the flow of lubricant into cylinder 14. Due to the pressurized piston design, dispensing gun 10 can operate while being held at any angle and in any orientation. In addition, the forward locking feature of cartridge piston 68 prevents cartridge piston 68 from being withdrawn, which prevents air, plural component mix 42, or other non-lubricant material from being drawn in to lubricant chamber 54, cylinder pathway 82 (as shown later in FIG. 5), or mix head pathway (as shown later in FIG. 6).

Depicted in FIG. 4 is one embodiment of the present invention, to which there are alternative embodiments. For example, cartridge 12 could be held in cartridge bay 62 using a latch or other mechanism, such as threads wherein cylinder bay 62 is tapped with threads.

Shown in FIG. 5 is a top cross-section view of dispensing gun 10 along line 5-5 in FIG. 1. Shown in FIG. 5 are cylinder 14, mix head 16, cartridge bay 62, piercer 78, and cylinder pathway 82. Cylinder pathway 82 is a lubricant channel within cylinder 14. In the illustrated embodiment, cylinder pathway 82 extends straight between cartridge bay 62 and mix head 16. Cylinder pathway 82 allows pressurized lubricant from the end of cartridge bay 62 to reach mix head 16.

Depicted in FIG. 5 is one embodiment of the present invention, to which there are alternative embodiments. For example, cylinder pathway 82 can extend in other orientations and can have multiple segments. Such embodiments allow cylinder pathway 82 to be routed around the other components in cylinder 14, such as the pneumatic system, including solenoid 36.

Shown in FIG. 6 is a side cross-section view of mix head 16 along line 6-6 in FIG. 2. Shown in FIG. 6 are cylinder 14, mix head 16, tip 18, purge rod 20, bearing sleeve 52, lubricant chamber 54, mix module 56, packing nut 58, packing housing 60, cylinder pathway 82, mix head pathway 84, check valve assembly 86, check valve seat 88, check valve ball 90, check valve spring 92, bleed port 94, bleed port screw 96, gas piston rod 98, and u-cup seal 100.

Mix head 16 is attached to and inset into cylinder 14. Cylinder pathway 82 comes up from the lower rear of mix head 16. Cylinder pathway 82 is then routed around at least one side of the rear of mix head 16 to an area near the upper side of the rear of mix head 16.

The parts and connections of mix head 16 are as described with FIGS. 3A-3B, with some additional features shown in FIG. 6. For example, mix head pathway 84 is fluidly connected to cylinder pathway 82. Connected to the rear end of mix head pathway 84 is check valve assembly 86. Check valve assembly 86 has check valve seat 88, check valve ball 90, and check valve spring 92. Check valve seat 88 is attached to mix head 16, and the front end of check valve spring 92 resting on a counterbore shelf in mix head pathway 84. Check valve ball 90 is positioned between check valve seat 88 and check valve spring 92. In addition, bleed port 94 is fluidly connected to mix head pathway 84. However, bleed port screw 96 is normally attached to mix head 16, and normally prevents lubricant flow through bleed port 94. Also fluidly connected to mix head pathway 84 is lubricant chamber 54.

As stated previously, purge rod 20 is slidably positioned in mix head 16. The rear end of purge rod 20 is connected to gas piston rod 98. As discussed with FIG. 1, there is a gas piston inside cylinder 14 that moves purge rod 20 by way of gas piston rod 98. Also near the rear end of purge rod 20 is u-cup seal 100. U-cup seal 100 is positioned between packing nut 58 and packing housing 60.

When cartridge 12 is pressurized (as discussed with FIG. 4), lubricant can travel from cylinder pathway 82 into mix head pathway 84. From there the lubricant can travel through check valve assembly 86 because the pressure forces check valve ball 90 off of check valve seat 88. This allows the lubricant to flow around check valve ball 90 and eventually into lubricant chamber 54.

In order to drain the air or other fluid that may be in cylinder pathway 82 or mix head pathway 84, bleed port screw 96 can be removed to let the fluid drain as the lubricant is progressing through cylinder pathway 82 and mix head pathway 84. Once the lubricant is in lubricant chamber 54, it bathes purge rod 20 and lubricates purge rod 20 as it slides back and forth within mix head 16. Lubricant is substantially sealed in lubricant chamber 54 and is substantially prevented from leaking rearward by u-cup seal 100. Lubricant is also substantially prevented from leaking forward into mix module 56, bearing sleeve 52, and tip 18 by the close fit of purge rod 20 in mix module 56. However, minute amounts of lubricant can be consumed by leakage, but more lubricant will be provided from cartridge 12 as needed.

The components and configuration of dispensing gun 10 as shown in FIG. 6 allow for lubricant to reach purge rod 20. However, check valve assembly 86 ensures that there will be no reverse flow in mix head pathway 84. The lubrication of purge rod 20 assists in the sliding of purge rod 20, which allows for the initiation and cessation of plural component mix 42 dispensing. In addition, lubrication chamber 54 is substantially sealed as to substantially prevent the leakage and loss of the lubricant.

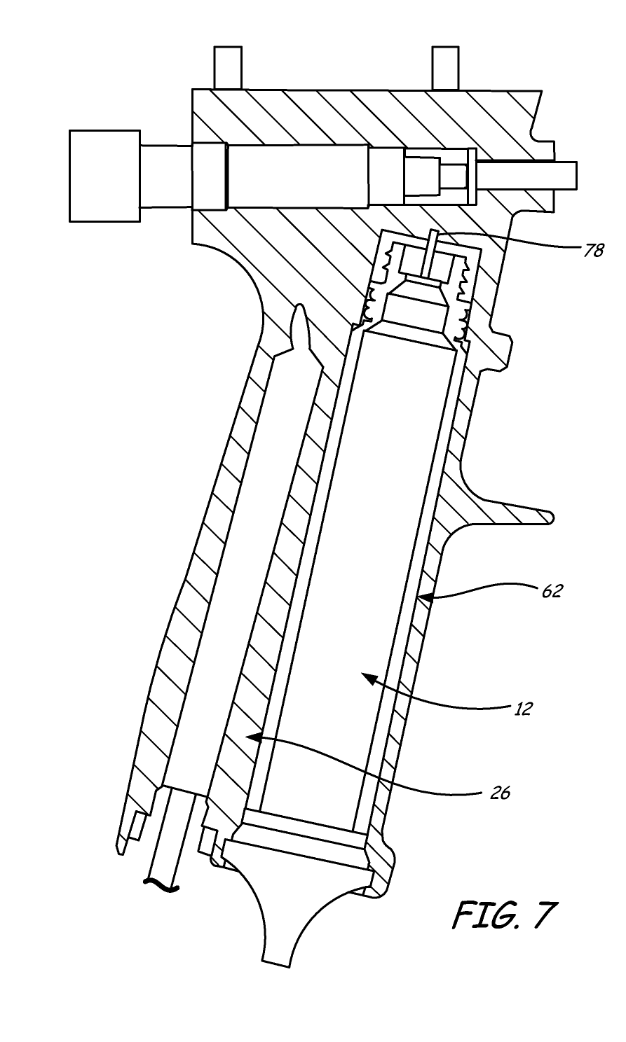

Shown in FIG. 7 is a side cross-section view of an alternate embodiment handle 26 along line 7-7 in FIG. 2. Shown in FIG. 7 are cartridge 12, handle 26, cartridge bay 62, and piercer 78. In the illustrated embodiment, cartridge bay 62 and piercer 78 are located in handle 26, which means that cartridge 12 is inserted in handle 12. However, these components function in the same manner as those described in FIG. 4. In such an embodiment, handle 12 has a pathway (not shown) that serves as a lubricant channel that is fluidly connected with cylinder pathway 82, such that lubricant can still reach mix head 16 (as shown in FIG. 6). Thereby, this alternate embodiment dispensing gun 10 operates in the same manner as the embodiment described in FIGS. 1-6.

It should be recognized that the present invention provides numerous benefits and advantages. For example lubrication of purge rod 20 is particularly helpful because of the high viscosities of first component 44, second component 46, and plural component mix 42. It is also advantageous due to the fact that plural component mix 42 is solidifying as it is being dispensed. For another example, cartridge 12 is attached to dispensing gun 10, which eliminates another fluid connection to metering system 38, and makes the lubrication system self contained. For a further example, cartridge 12 is easily replaceable and externally visible so that dispensing gun 10 can be quickly replenished with lubricant to ensure continuous lubrication of purge rod 20.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A dispensing gun comprising:
a mix head for combining at least two fluid components, the mix head having at least two fluid component inlets and a mixing chamber between the at least two fluid component inlets;
a purge rod slidably positioned within the mix head, the purge rod having at least two positions, a forward position for preventing flow from the at least two fluid component inlets, and a rearward position allowing flow from the at least two fluid component inlets into the mixing chamber;
an actuator connected to the purge rod for moving the purge rod between the forward position and the rearward position;
a lubrication chamber rearward of the mixing chamber, within which the purge rod is slidably positioned, the lubrication chamber providing lubricant to the purge rod; and
a lubricant cartridge containing lubricant, the lubricant cartridge being in fluid communication with the lubrication chamber.

2. The dispensing gun of claim 1, wherein the purge rod and the mixing chamber seal one end of the lubrication chamber.

3. The dispensing gun of claim 1, wherein a forward end of the purge rod does not enter lubrication chamber when purge rod is in the rearward position.

4. The dispensing gun of claim 1, and further comprising:
a pressurized gas source connected to both the lubricant cartridge and the actuator.

5. The dispensing gun of claim 4, wherein the actuator is a pneumatic system.

6. The dispensing gun of claim 5, wherein the pneumatic system is controlled by an electric solenoid.

7. The dispensing gun of claim 4, wherein lubricant is forced into the lubrication chamber by the pressurized gas source.

8. The dispensing gun of claim 1, and further comprising:
a housing;
a cartridge bay; and
a lubricant pathway within the housing that is fluidly connected to the lubricant chamber and the cartridge bay.

9. The dispensing gun of claim 8, and further comprising:
a check valve in the lubricant pathway to prevent reverse flow of the lubricant.

10. The dispensing gun of claim 1, wherein the lubricant cartridge has a piston that forces the lubricant into the lubrication chamber.

11. The dispensing gun of claim 1, wherein the lubricant cartridge is removable.

12. A dispensing gun comprising:
a housing;
a lubricant cartridge containing lubricant, the lubricant cartridge being insertable into the housing;
a mixing mechanism attached to the housing for mixing at least two fluid components;
a purge rod slidably positioned in the mixing mechanism; and
a lubricant pathway connecting the mixing mechanism with the lubricant cartridge, for delivering lubricant to the purge rod.

13. A dispensing gun of claim 12, wherein the mixing mechanism has a mixing chamber and a lubrication chamber, through both of which the purge rod is slidably positioned.

14. A dispensing gun of claim 13, wherein the lubricant pathway within the mixing mechanism is fluidly connected to the lubrication chamber.

15. The dispensing gun of claim 14, and further comprising:
a check valve in the lubricant pathway to prevent reverse flow of the lubricant.

16. A dispensing gun of claim 12, and further comprising:
a gas piston actuator for sliding the purge rod.

17. The dispensing gun of claim 12, and further comprising:
a seal over an end of the cartridge; and
a piercer attached to the housing for piercing the seal when the lubricant cartridge is inserted into the housing.

18. A method of operating a dispensing gun comprising:
pressurizing a first fluid component;
pressurizing a second fluid component;
pressurizing a lubricant cartridge that is attached to the dispensing gun;
moving a purge rod rearward to allow the flow of the first and second fluid components;
mixing the first and second fluid components in a mixing chamber;
lubricating the purge rod with the pressurized lubricant continually during operation of the dispensing gun; and
preventing substantially lubricant from reaching the mixing chamber.

19. The method of operating a dispensing gun of claim 18, and further comprising:
moving the purge rod forward to evacuate the mixing chamber of the first and second fluid components and prevent the flow of the first and second fluid components.

20. The method of operating a dispensing gun of claim 18, wherein the lubricating of the purge rod occurs in a lubrication chamber.
